(19) United States
(12) Patent Application Publication
(10) Pub. No.: US 2008/0148922 A1
(43) Pub. Date: Jun. 26, 2008

(54) DIGITAL TURNTABLE SCRATCH INTERFACE

(76) Inventor: Robert Morra, Bolton (CA)

Correspondence Address: BERESKIN AND PARR, 40 KING STREET WEST, BOX 401, TORONTO, ON, M5H 3Y2, omitted

(21) Appl. No.: 11/613,474

(22) Filed: Dec. 20, 2006

(51) Int. Cl. G10H 1/00

(52) U.S. Cl. 84/600

(57) ABSTRACT

A scratch interface tactilely interacted by a user and adapted for positioning on a digital turntable is disclosed. The scratch interface comprises a positioning element that mechanically engages with a complementary locking element coupled to the platter of the digital turntable. The platter of the digital turntable rotates in synchronicity with the scratch interface. The user interacts with a vinyl user surface of the scratch interface, permitting the user to manipulate the musical output of the digital turntable.

### FIELD OF THE INVENTION

The exemplary embodiments described herein relate to an apparatus for manually interacting with a digital turntable. More particularly, the exemplary embodiments relate to a scratch interface through which a user tactilely interacts with the rotation of a digital turntable.

### BACKGROUND OF THE INVENTION

The use of digital audio signal players is widespread in the storage and reproduction of music. There are a number of different types of digital audio signal players, which can play music stored in a number of different formats. They include, for example, CD/MP3 readers, flash memory players, and small hard drive players. The small size and simplicity of use of these digital audio signal players, and their ability to store large quantities of music make them a popular modern means of enjoying music.

Vinyl records, however, still retain a popular following with, for example, disc jockeys [hereafter “DJ”]. DJs continue to “spin” vinyl records on analog turntables because it allows them to manually manipulate the music being played. This, for example, can be helpful in allowing the DJ to manually adjust the beat of the music to allow seamless mixing of different music sources. The manual manipulation also allows DJs to engage in “scratching”, where the vinyl record rotation is manually reversed, or sped up to permit the DJ to produce desired sounds.

In order to permit DJs to experience this same manual control over the music being played with a digital audio signal player, digital turntables have been developed. Digital turntables bring some of the characteristics of traditional analog turntables to digital audio signal players. Digital turntables, for example, may rotate or “spin” a platter in relation to a digital audio signal from a digital audio signal player, permitting the DJ to manually manipulate the music output from the digital turntable through tactile control of the spinning of the digital turntable.

The control of the spin of a turntable, including a digital turntable, is very sensitive and requires a DJ to be comfortable and have a suitable means of tactile interaction with the digital turntable. DJs also often operate their digital turntables, sometimes know as “spinning”, in clubs or other locations where the surrounding conditions are less than ideal. For example, the club may be very hot, and the DJ may have sweaty hands, or the lighting may be very dim, or the DJ may be spinning for long periods of time. Proper tactile interaction with the digital turntable is therefore important for enabling the DJ to perform properly.

Accordingly, there is a need for an interface that permits a DJ to comfortably tactilely interact with a digital turntable and its musical output.

### SUMMARY OF THE INVENTION

The embodiments described herein are directed to a scratch interface for user interaction with a digital turntable. The scratch interface is adapted for positioning on a platter of the digital turntable. The scratch interface comprises a user surface, and an optional positioning element.

The user surface is made of vinyl. The optional positioning element may be formed in the scratch interface and corresponds to a complementary locking element coupled to the platter of the digital turntable.

In one embodiment, the user surface includes a plurality of grooves. The scratch interface may also include a central aperture. Optionally, the grooves may correspond to music.

In one embodiment the scratch interface includes a platter surface that includes a gripping element. The gripping element engages with the platter of the digital turntable.

### BRIEF DESCRIPTION OF THE DRAWINGS

For a better understanding of the present invention, and to show clearly how it may be carried into effect, reference will now be made, by way of example, to the accompanying drawings which show a preferred embodiment of the present invention, in which:

FIG. 1 is a perspective view of an example scratch interface;

FIG. 2A is a top view of the scratch interface of FIG. 1;

FIG. 2B is a bottom view of the scratch interface of FIG. 1;

FIG. 2C is a side elevation view of the scratch interface of FIG. 1;

FIG. 3A is a top view of a further example scratch interface;

FIG. 3B is a bottom view of the scratch interface of FIG. 3A;

FIG. 3C is a side elevation view of the scratch interface of FIG. 3A;

FIG. 4A is a top view of a further example scratch interface;

FIG. 4B is a bottom view of the scratch interface of FIG. 4A;

FIG. 4C is a side elevation view of the scratch interface of FIG. 4A;

FIG. 5A is a top view of a further example scratch interface;

FIG. 5B is a side elevation view of the scratch interface of FIG. 5A;

FIG. 6 is a perspective view of a further example scratch interface with a cue indicator; and

FIG. 7 is a perspective view of an example scratch apparatus.

### DETAILED DESCRIPTION OF THE INVENTION

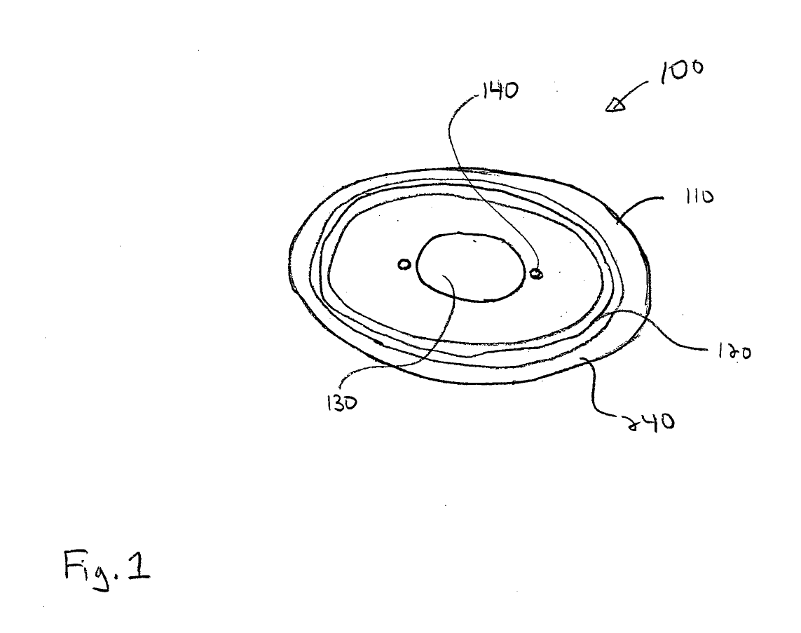

Reference is first made to FIG. 1, which illustrates a first exemplary embodiment of a scratch interface 100. The scratch interface 100 includes a user surface 110, a central aperture 130, and positioning elements 140. The scratch interface 100 may also include grooves 120.

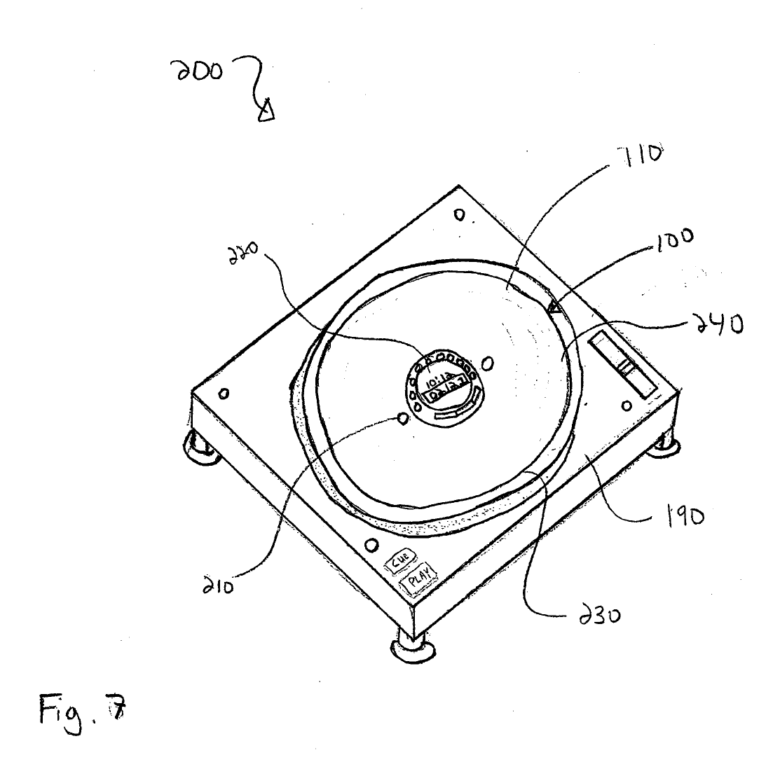

Reference is now made to FIGS. 1 and 7. FIG. 7 shows an example embodiment of a scratch apparatus 200. Scratch apparatus 200 comprises a scratch interface 100, and a digital turntable 190. The digital turntable includes a platter 230, a locking element 210 and a display element 220. A person skilled in the art would understand that the following paragraphs outline only a few examples of the function and basic use of a digital turntable, in order to give a basic understanding of the context of the present description. Additional examples are possible, and this description should not be viewed as being limited by these examples.

The user surface 110 is the surface of the scratch interface 100 that is tactilely interfaced by a user, typically a DJ. The user usually places their hands, or fingers on the user surface 110. The user can apply varying levels of pressure to the user surface 110 to vary their interaction with the scratch interface 100. As is discussed in more detail below, the scratch interface 100 is typically coupled to the platter 230 of the digital turntable 190, such that the scratch interface 100 and platter 230 rotate in synchronicity. The user's alteration of the rotation of the scratch interface 100 directly alters the rotation of the platter 230 of digital turntable 190, and therefore alters the digital turntable's 190 musical output.

The user's application of varying levels of pressure on the user surface 110 of the scratch interface 100 allows the user to manipulate the rotation of the platter 230 of digital turntable 190. For example, the user may apply a light pressure to the user surface 110 slowing down the rotation of the platter 230 of digital turntable 190, or with the user may apply a greater amount of pressure to stop the rotation of the platter 230 of digital turntable 190. The platter 230 of digital turntable 190 typically rotates in synchronicity with a digital audio signal, such that, as discussed above, when the rotation of the platter 230 of digital turntable 190 is altered, the music output of the digital turntable 190 is also altered. For example, slowing the rate rotation of the platter 230 of digital turntable 190 will slow the music being played, or increasing the rate of rotation of the platter 230 of digital turntable 190 will increase the speed of the music being played, or stopping the rotation of the digital turntable 190 will stop the music output.

The user can therefore, for example, slow the rotation of the digital turntable 190 through tactile interaction with the user surface 110 of scratch interface 100 to manually adjust the beat of the music being played. The manual alteration of the beat of the music permits the user to match beats, and mix different sources of music being played, for example, on different turntables (digital or analogue). The user can also create scratch sounds through their tactile interaction with the user surface 110 of scratch interface 100 to speed up, slow down or stop the musical output of the digital turntable 190.

The digital audio signal provided the digital turntable 190 may originate, for example, from digital audio signal players such as CD or MP3 readers, or from a flash memory player, or from a hard drive player. These digital audio signal players permit the user to have access to huge libraries of music in a compact, transportable format. The digital turntable 190 permits them to interact with and manipulate the musical output of the music stored on the digital audio signal players.

Typically, the user surface 110 is made of vinyl. This may be achieved through the scratch interface 100 being formed entirely of vinyl, such as with a traditional vinyl record. Alternatively, only the user surface 110 of scratch interface 100 may be made of vinyl. The vinyl user surface 110 may be, for example, applied to a surface of an alternate material, which is shaped appropriately.

In one embodiment, the vinyl used is black vinyl. In other embodiments the scratch interface 100 may be translucent vinyl. The translucent vinyl may be coloured, for example, white or red. In other embodiments, a person skilled in the art would understand, the vinyl may be any colour. The vinyl is typically similar to the vinyl found in traditional analogue records. In other embodiments, the scratch interface may be a vinyl “picture disc”, in which a picture has been printed, embedded, adhered or otherwise formed on the user surface.

The user surface 110 may also include grooves 120, as seen in FIGS. 1, 2A and 7. A person skilled in the art would understand that the grooves 120 may correspond to music, as is the case, for example, in a traditional analogue vinyl record. The grooves 120 may, alternatively, not correspond to music. The grooves 120 may, for example, be a feature added to the user surface 110 of the scratch interface 100. The grooves 120 are typically helical, with a first end of the helix adjacent to the outer edge 240 of the scratch interface 100, and a second end of the helix adjacent the central aperture 130. The grooves 120 may also be, for example, centered on the central aperture 130. The scratch interface 100 may comprise a single helical groove 120, or the scratch interface 100 may comprise a plurality of concentric grooves 120.

The vinyl make up of the user surface 110 gives the user, such as a DJ, a superior and familiar surface with which to tactilely interact with the scratch interface 100 and therefore the musical output of the digital turntable 190. The utility of the vinyl user surface 110 may also be aided by the presence of grooves 120. The vinyl user surface 110 together with the grooves 120, or alone without the grooves 120, is effective at absorbing and distributing moisture and heat, typically from the user's hand. The user surface 110 is thereby kept in proper condition for the user to effectively scratch and otherwise manipulate the musical output of the digital turntable 190 through tactile interaction with the user surface 110 of the scratch interface 100.

In addition, a user surface 110 made of, or covered with vinyl, together with grooves 120 or without grooves 120, gives the user a user surface 110 with a friction coefficient that is familiar to most users who are skilled in the art. The friction coefficient of the vinyl is well adapted for the manual tactile manipulation commonly performed by a user skilled in the art, such as a DJ. This permits the user to properly, and predictably, apply varying degrees of pressure to the user surface 110 yielding results such as, for example, manually adjusting the beat of the music or scratching. The user can therefore effectively manipulate the rotation of the digital turntable 190 through tactile interaction with the user surface 110 of scratch interface 100.

As seen in FIG. 1 to 7 the central aperture 130 is typically located in the center of the scratch interface 100. The central aperture 130 may vary in size. In some example embodiments (not shown), the scratch interface 100 does not have a central aperture 130. The central aperture 130 can help the user to properly center and place the scratch interface 100 onto the platter 230 of the digital turntable 190. Proper placement of the scratch interface 100 is required in order for the scratch interface 100 to properly rotate on the platter 230 of digital turntable 190. The central aperture 130 may also help to mechanically interlock the scratch interface 100 onto the digital turntable 190, ensuring that the scratch interface 100 is rotating in synchronicity with the platter 230 of the digital turntable 190.

As seen in FIG. 7, the central aperture 130 may also be sized to permit the user to visually observe a display element 220 of the digital turntable 190. The central aperture 130 may permit the user to monitor the track number, timing of the track, and any other values displayed on the display interface 220. In addition, if there are any turntable controls located on the display interface 220, the central aperture 130 permits the user to interact with those controls. In another embodiment the scratch interface 100 may include a central aperture sized to interlock with an indexing pin (not shown) located at the rotational center of the platter 230 of the digital turntable 190. For example, the central indexing pin located on a traditional analogue turntable.

Scratch interface 100 may also include at least one positioning element 140. Reference is now made to FIGS. 1 to 5B inclusive, and FIG. 7. The positioning element 140 can take many forms. The scratch interface 100 can include only one positioning element 140 (not shown), or it may alternatively, include two positioning elements 140, as seen in FIGS. 1 to 5B inclusive, and FIG. 7. A person skilled in the art would also understand that scratch interface 100 might, alternatively, include three or more positioning elements 140 (not shown). The positioning elements 140 are typically formed into scratch interface 100 to complement the locking elements 210 of platter 230 of the digital turntable 190. The locking element 210, in turn, is coupled to the platter 230 of the digital turntable 190. The locking element 210 may be formed in the platter 230, or it may be simply coupled to the platter 230. The locking element 210 may be coupled to the platter 230 at the time of its manufacture, or it may be added later by the manufacturer or by a user.

The positioning element 140 serves two main functions. First, the positioning element 140 helps the user to properly position the scratch interface 100 onto the platter 230 of the digital turntable 190. The positioning elements 140 ensure that the scratch interface 100 is in position to properly rotate on the digital turntable 190. The second main function served by the positioning element 140 is to mechanically engage the scratch interface 100 with a complementary locking element 210 on the platter 230 of digital turntable 190. Typically, the positioning element 140 is dimensioned to mechanically engage snugly with the locking element 210 of the platter 230 of the digital turntable 190. The snug fit leaves very little variability or play in the position of the scratch interface 100 relative to the platter 230 after the scratch interface 100 is positioned on the platter 230.

The snug engagement of the positioning element 140 of the scratch interface 100 with the locking element 210 of the platter 230 ensures that the user has full control over the rotation of the digital turntable 190, when the user interacts with the user surface 110 of the scratch interface 100. Alternatively, the positioning element 140 may be adapted to frictionally engage the locking element 210, ensuring that the scratch interface 100 rotates in substantial synchronicity with the platter 230.

As mentioned earlier, the positioning element 140, and the complementary locking element 210 may take many possible forms. A few of these are described here, however a person skilled in the art would understand that these are but a few example embodiments amongst many possible embodiments. An example is seen in FIGS. 1, 2A, 2B, 2C, and 7 where an aperture is the positioning element 140 formed in the scratch interface 100. A complementary indexing pin is the locking element 210 coupled to the platter 230. When the scratch interface 100 is positioned on the platter 230, the indexing pin mechanically engages the aperture yielding a mechanical interlock between the scratch interface 100 and the platter 230.

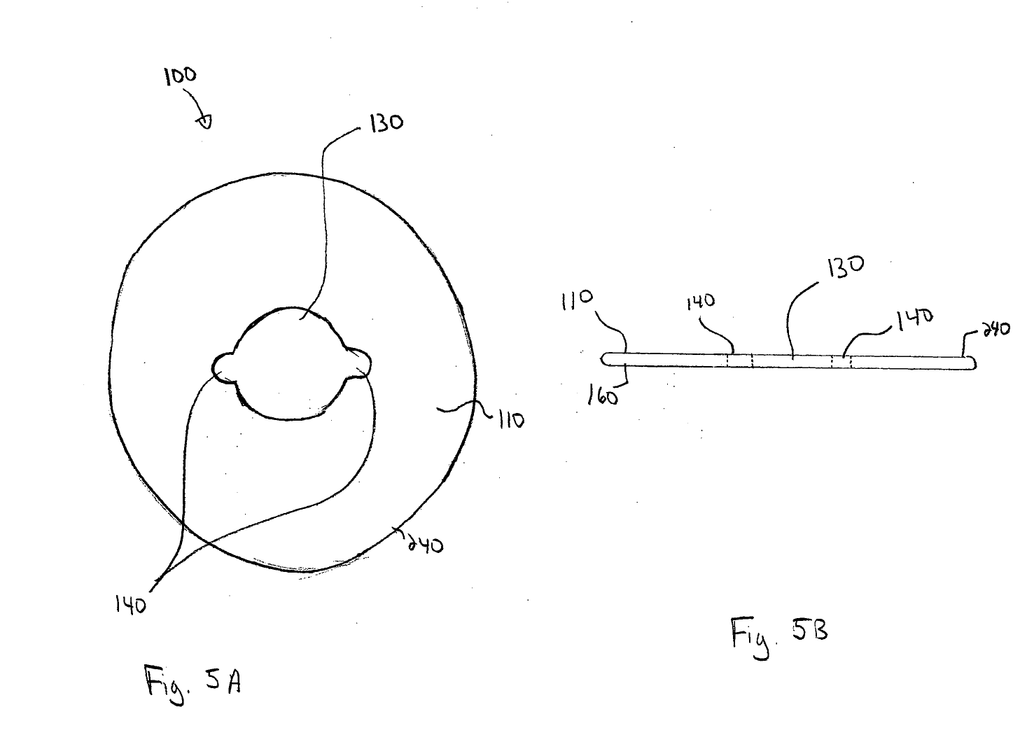

Alternatively, as seen in FIGS. 5A and 5B, the positioning element 140 may be formed adjacent to the central aperture 130. In this example embodiment, the positioning element 140 may be only partly encircled by the material of the scratch interface 100. The complementary locking element 210 (not shown) could be an indexing pin sized and shaped to mechanical engage and fit snugly within the positioning element 140 displayed.

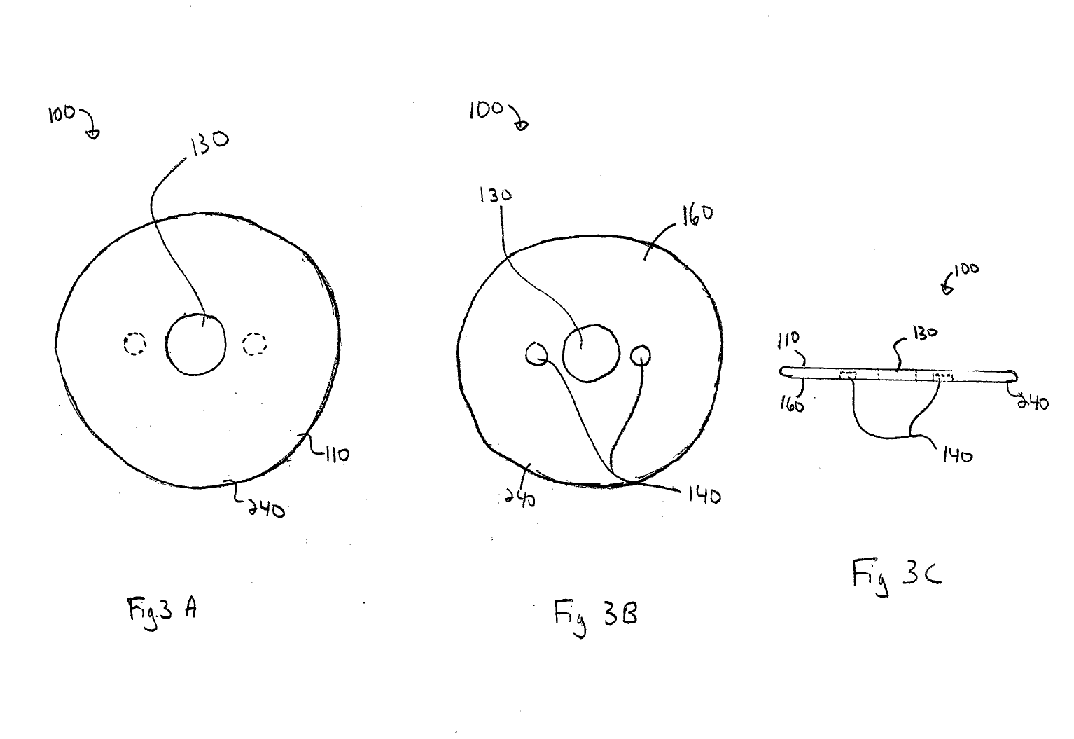

Alternatively, reference is made to FIGS. 3A, 3B and 3C which display a further example embodiment of a positioning element 140. In this example, the positioning element 140 is a detent formed in the scratch interface 100. The detent positioning element 140 is sized to mechanically engage a corresponding protrusion locking element 210 (not shown) coupled to the platter 230.

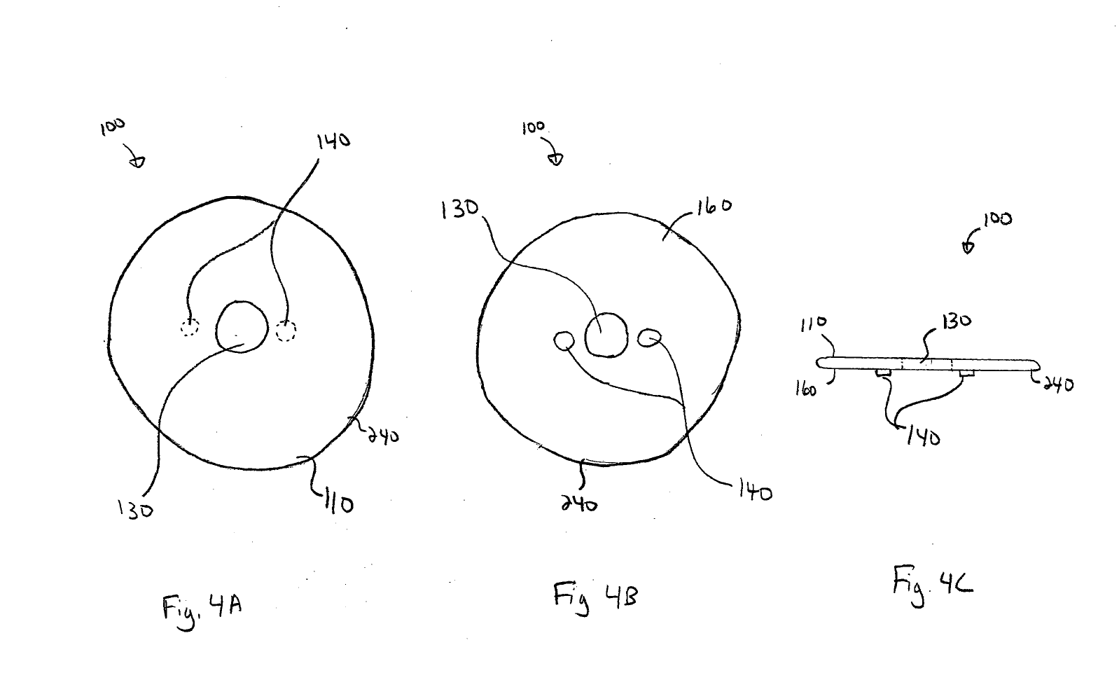

Conversely, as seen in FIGS. 4A, 4B and 4C, the positioning element 140 may be a protrusion formed in the scratch interface 100. The protrusion positioning element 140 is sized to mechanically engage a corresponding detent locking element 210 coupled to the platter 230 of the digital turntable 190.

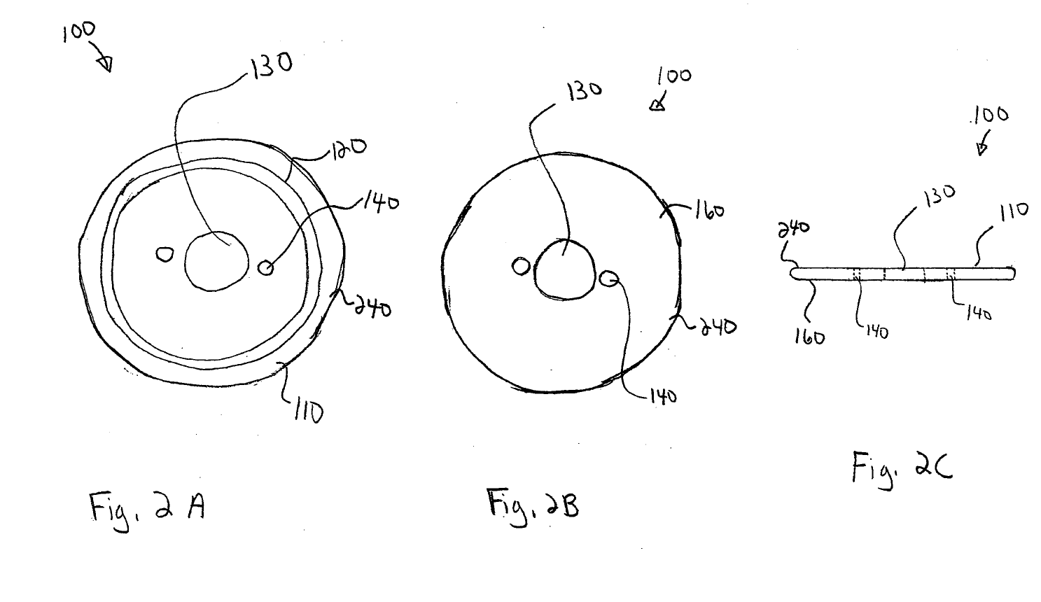

As seen in FIGS. 2B, 3B and 4B the scratch interface 100 also comprises a platter surface 160. The platter surface 160 is adjacent to the platter 230 of the digital turntable 190 when the scratch interface 100 is properly positioned on the digital turntable 190. The platter surface 160 may also (similarly to the user surface 110) comprise grooves (not shown). In addition the platter surface 160 may be coated with paint, such as Krylon paint. The presence of the paint and grooves, may serve to increase the frictional engagement between the platter 230 and the scratch interface 100. This helps to ensure proper mechanical engagement between the scratch interface 100 and the platter 230, even if there is a small amount of play in the fit between the positioning element 140 and the locking element 210.

The presence of paint on the platter surface 160, may also aid the user to position the proper platter surface 160 of the scratch interface 100 adjacent to the platter 230, ensuring that when in use the user is tactilely interfacing with the proper user surface 110 of the scratch interface 100. The visibility of the paint can be very helpful to the user in areas of poor lighting, such as a club.

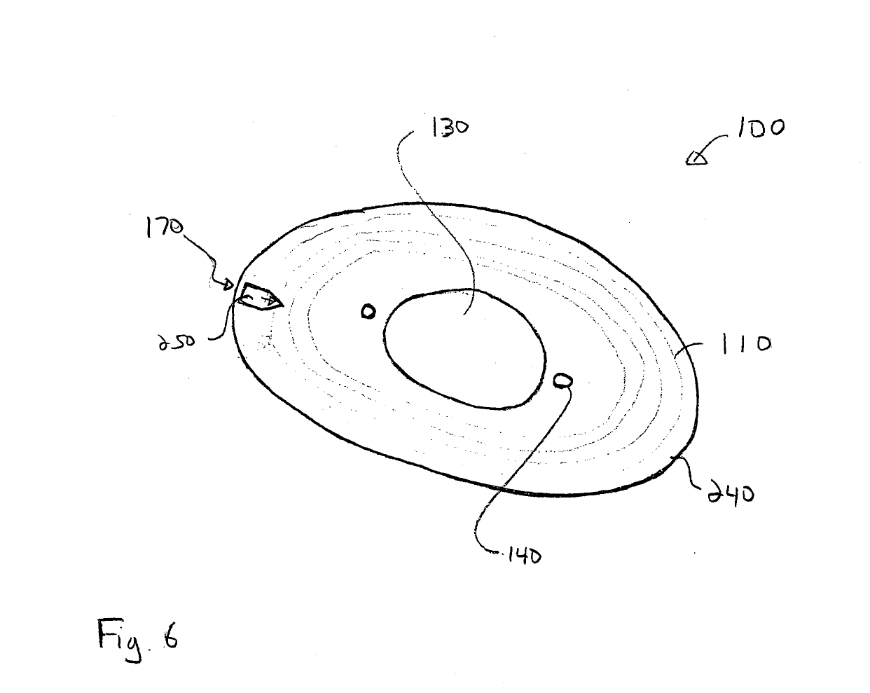

Reference is now made to FIG. 6. FIG. 6 shows the scratch interface 100 further comprising a cue indicator 170. The cue indicator 170 has a sticky surface (not shown), and an indicator surface 250. The cue indicator 170 is typically manufactured with a removable backing placed over the sticky surface (not shown). When the user wishes to mark a particular musical moment, they can remove the removable backing placed over the sticky surface (not shown), and selectively place the sticky surface (not shown) of the cue indicator 170 onto the user surface 110 of the scratch interface 100. The location of the cue indicator 170 marks the rotational position of the scratch interface 100 corresponding to the desired musical moment. The indicator surface 250 of the cue indicator 170 is the visible surface of the cue indicator 170 which the user can see. The user can then observe and use the indicated “cued” location to aid in their manipulation of the scratch interface 100, and the corresponding musical output of the digital turntable 190.

For example, the user can stop the rotation of the scratch interface 100 at the location of the cue indicator 170, and scratch at that location. As a further example, the user can move the scratch interface 100 to the cued position, let a short excerpt of music be output, then return the scratch interface 100 to the same indicated position, and let the same musical excerpt play again.

Reference is once again made to FIGS. 2B, 3B, and 4B, which show a platter surface 160 of the scratch interface 100. A gripping element (not shown) can also be added to the platter surface 160 of the scratch interface 100. For example sandpaper, or rubber may be attached to the platter surface 160 by means of an adhesive, or by being formed in the platter surface 160 of the scratch interface 100. The gripping element (not shown) is adapted to frictionally engage with the platter 230 of the digital turntable 190. The scratch interface 100 may include a gripping element (not shown) in addition to a positioning element 140, or the gripping element may be used on a scratch interface 100 without a positioning element 140.

The gripping element (not shown), through friction, mechanically engages the scratch interface 100 to the platter 230 of the digital turntable 190, yielding substantially the same result as the use of the positioning element 140 and locking element 210. Alternatively, the use of a gripping element may permit some slip between the scratch interface 100 and the platter 230, which some user's may find helpful for producing desired musical outputs.

While what has been shown and described herein constitutes one exemplary embodiment of the subject invention and while some variations of the embodiment have also been described, it should be understood that various modifications and adaptions of such embodiments can be made without departing from the present invention, the scope of which is defined in the appended claims.

1. A scratch interface adapted for positioning on a platter of a digital turntable, the scratch interface comprising:
a user surface; and
a positioning element formed in the scratch interface, wherein the positioning element corresponds to a complementary locking element coupled to the platter,
and wherein the user surface is made of vinyl.

2. The scratch interface of claim 1 wherein the positioning element is adapted to mechanically engage the locking element.

3. The scratch interface of claim 1 wherein the positioning element is adapted to frictionally engage the locking element.

4. The scratch interface of claim 1 wherein the positioning element is an aperture adapted to interlock with an indexing pin on the digital turntable.

5. The scratch interface of claim 1 wherein the positioning element is a detent and wherein the locking element is a protrusion corresponding to the detent.

6. The scratch interface of claim 1 wherein the positioning element is a protrusion and wherein the locking element is a detent corresponding to the protrusion.

7. The scratch interface of claim 1 wherein the scratch interface is formed of vinyl.

8. The scratch interface of claim 1 further comprising a central aperture.

9. The scratch interface of claim 8 wherein the central aperture is sized to fit a display element.

10. The scratch interface of claim 1 wherein the user surface is grooved.

11. The scratch interface of claim 10 wherein the user surface has at least one helical groove corresponding to music.

12. The scratch interface of claim 10 wherein the user surface has a plurality of concentric grooves.

13. The scratch interface of claim 1 further comprising a platter surface.

14. The scratch interface of claim 13 wherein the platter surface is grooved.

15. The scratch interface of claim 13 wherein the platter surface is substantially covered by a paint coating.

16. The scratch interface of claim 1 further comprising:
a cue indicator adapted for placement on the scratch interface,
wherein the cue indicator has a sticky surface and an indicator surface,
wherein the cue indicator sticky surface is selectively placed on the user surface of the scratch interface by a user.

17. A scratch interface adapted for positioning on a platter of a digital turntable, the scratch interface comprising:
a user surface; and
a platter surface including a gripping element to engage a platter of the digital turntable,
wherein at least the user surface is made of vinyl.

18. The scratch interface of claim 17 wherein the gripping element is sandpaper.

19. The scratch interface of claim 17 wherein the gripping element is rubber.
